(19) United States
(12) Patent Application Publication
(10) Pub. No.: US 2016/0238148 A1
(43) Pub. Date: Aug. 18, 2016

(54) MINIMUM CAVITY RELIEF VALVE

(71) Applicants: Martin P. MICCORMICK, Forest Lake, MN (US); Ryan F. BUTLER, Brooklyn Park, MN (US); GRACO MINNESOTA INC., Minneapolis, MN (US)

(72) Inventors: Martin P. McCormick, Forest Lake, MN (US); Ryan F. Butler, Brooklyn Park, MN (US)

(21) Appl. No.: 15/024,581

(22) PCT Filed: Oct. 10, 2014
(86) PCT No.: PCT/US2014/060024

§ 371 Date: Mar. 24, 2016

Related U.S. Application Data
(60) Provisional application No. 61/890,229, filed on Oct. 12, 2013.

(51) Int. Cl. F16K 24/04; B05B 15/04; F16K 31/60; B05B 9/04; F16K 1/12; F16K 27/02

(52) U.S. Cl. CPC F16K 24/04; F16K 1/12; F16K 27/02; F16K 31/60; B05B 9/0403; B05B 15/0406

(57) ABSTRACT

The disclosure addresses a relief valve suitable for use in systems for delivering relatively viscous fluids. The described relief valve includes a housing and a valve mechanism moveable relative to an opening into the housing to allow or prevent flow from a flow path adjacent the relief valve into and through the housing. The relief valve is configured to minimize, and in many examples, essentially eliminate, a cavity between the housing opening and the adjacent flow path. Elimination of this cavity offers significant advantages as it minimizes or eliminates a location for pumped materials to accumulate and/or cure, which can lead to impairment or disabling of the relief valve operation.

### RELATED APPLICATION

This application claims priority to U.S. Provisional Patent Application No. 61/890,229, entitled “ZERO CAVITY RELIEF VALVE,” filed on Oct. 12, 2013, which is incorporated herein by reference in its entirety.

### BACKGROUND

The present invention relates generally to pumping and spraying systems and, more particularly, to pressure relief valves suitable for use in such pumping and spraying systems.

Peristaltic pumps, piston pumps and double-diaphragm pumps are commonly used to pump highly viscous materials. The pumps transport and inject under pressure various materials ranging from fluid slurries to heavy sanded grouts, such as cement slurries, sanded cement mixes, bentonite mixes (with or without sand), repair mortars, high strength non-shrink grouts and self-leveling products. Common characteristics of these materials are that they are often fluid or semi-fluid, have a relatively high specific gravity and are often granular in composition (all these types of materials are referenced herein as a “fluid” or as “fluids”). Generally, such highly viscous materials can be considered to be materials that would be resistant to pouring from a pail. When the material is moving freely out of the pump and through hoses, the material generally maintains its integrity. However, under pressure the materials tend to settle out of suspension and agglomerate within the hose and the discharge portion of the pump. When this occurs, the pressure within the entire discharge system can increase to the maximum pump capacity.

In order to clear the agglomerated material, an operator will customarily actuate a manually operated pressure relief valve to relieve system pressure so the hoses can safely be disconnected and cleaned. Unfortunately, due to the geometry of these types of valves, typically lever-actuated butterfly or ball valves, there is usually a considerable distance between the flow line and the actual valve mechanism that forms a dead space. The dead space can become plugged with the agglomerated material rendering the valve inoperable. In some circumstances the material can cure or harden, or otherwise generally solidify, within the dead space rendering the valve useless and frequently necessitating its replacement. A ball-type relief valve has been designed to reduce dead space, as is described in U.S. Pat. No. 7,644,904.

### SUMMARY

A relief valve comprises a housing and a valve member moveable relative to an opening into the housing to allow or prevent flow from a flow path adjacent the relief valve into and through the housing. The relief valve is configured to minimize, and in many examples, essentially eliminate, a cavity between the housing opening and the adjacent flow path. In some example configurations, the relief valve includes a cap which couples to the housing. In many examples, the moveable valve member is longitudinally moveable, such as in the form of a plunger configured to reciprocate within the housing. In one such example configuration, the housing extends between an inlet end and an outlet end, and includes a valve seat disposed proximate the inlet end, and a port disposed between the inlet end and the outlet end. The cap is connected to the housing at or near the outlet end. In some embodiments, the plunger extends through the cap and into the housing to the inlet end to selectively engage the valve seat.

### BRIEF DESCRIPTION OF THE DRAWINGS

FIG. 1 is a schematic of a pumping and spraying system in which the minimum cavity relief valve of the present invention may be used.

FIG. 2 is a cross-sectional view of a prior art relief valve having a dead space between the flow line and the relief valve mechanism.

FIG. 3 is a cross-sectional view of a minimum cavity relief valve of the present invention in which the relief valve mechanism is positioned in close proximity to the flow line.

### DETAILED DESCRIPTION

In this description, references to “one embodiment” or “an embodiment,” or to “one example” or “an example” in this description are not intended necessarily to refer to the same embodiment or example; however, neither are such embodiments mutually exclusive, unless so stated or as will be readily apparent to those of ordinary skill in the art having the benefit of this disclosure. Thus, a variety of combinations and/or integrations of the embodiments and examples described herein may be included, as well as further embodiments and examples as defined within the scope of all claims based on this disclosure, as well as all legal equivalents of such claims.

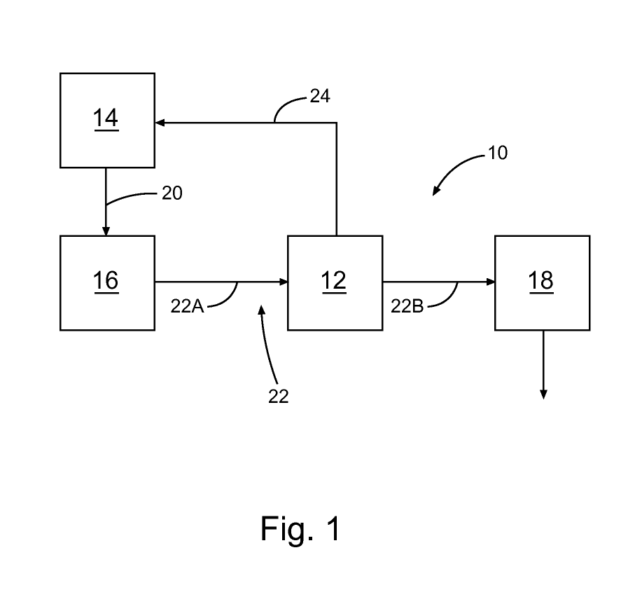

FIG. 1 is a schematic of pumping and spraying system 10 in which a minimum cavity relief valve 12 in accordance with the present invention may be used. System 10 includes container 14, pump 16 and spray mechanism 18. Container 14 comprises a hopper or some similar vessel into which a material for pumping and spraying is loaded. The material may comprise mortar, grout or any of the aforementioned materials. Container 14 feeds the material into an inlet of pump 16 through feed line 20. Pump 16 may comprise any suitable pump as is known in the art for pumping highly viscous materials. In various embodiments, pump 16 may comprise a peristaltic pump, a piston pump or a diaphragm pump. Pump 16 pumps the material to spray mechanism 18 through high pressure flow line 22, which comprises sections 22A and 22B. Spray mechanism 18 may be manually operated to discharge pressurized material at a desired location. In various embodiments, spray mechanism 18 may comprise any suitable mechanism for dispersing or otherwise placing the material as required for the specific application at hand, for example, e.g., a nozzle, spray gun or spray wand. In order to facilitate depressurizing of system 10, such as for shut-down and cleaning of system 10, high pressure flow line 22 is provided with relief valve 12. In the present example, relief valve 12 is provided in a T-fitting that couples a relief line 24 with sections 22A and 22B of flow line 22. Relief line 24 may feed back into container 14. The relief valve 12 may be constructed in accordance with any of the configurations discussed later herein.

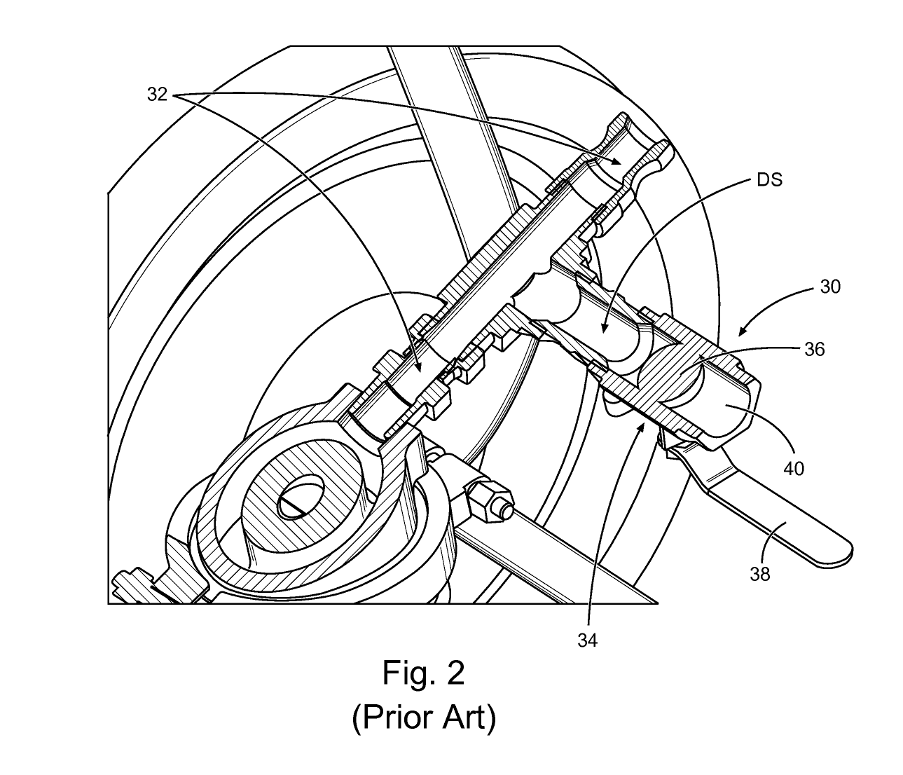

FIG. 2 is a cross-sectional view of a prior art relief valve 30 having dead space (“DS”) between flow line 32 and relief valve mechanism 34. Relief valve mechanism 34 comprises ball 36, which is rotated by lever 38. Housing 40 for ball 36 is spaced from flow line 32 by an extension member 42. As such, extension member 42 forms an elongated channel that can become fouled and plugged with material from within flow line 32. This fouling material can impair or prevent operation of the relief valve when ball 36 is rotated when it is desired to allow material to flow in and through housing 40. The relief valve described with reference to FIG. 2 operates in a substantially similar fashion as the prior art valve described in U.S. Pat. No. 7,644,904, except as to placement of the ball as described in that patent.

In order to reduce dead space within the T-fitting of the type depicted in FIG. 2, it is desirable that the valve mechanism of relief valve be positioned as close as possible to flow line 22. The minimum cavity relief valve of the present invention eliminates dead space DS by positioning the inlet to the relief valve mechanism in “close proximity” to the flow line. As used herein, the term “close proximity” is used to define a relationship in which relief valve closure mechanism (for example the valve seat that is engaged by a valve member to close flow within the valve) is sufficiently close to the primary flow path through flow line 22 as to eliminate a gap in which material from flow line 22 can accumulate in a sufficient volume as to impair the function of the relief valve. It is preferred that any gap between the valve seat and the nominal dimension of the flow path will be less than +/− 0.15 inch. In view of the objective that the new relief valve configuration eliminates any cavity adjacent the relief valve cavity sufficient to accumulate a potentially problematic volume of material, the relief valve may also be termed a “zero cavity relief valve.”

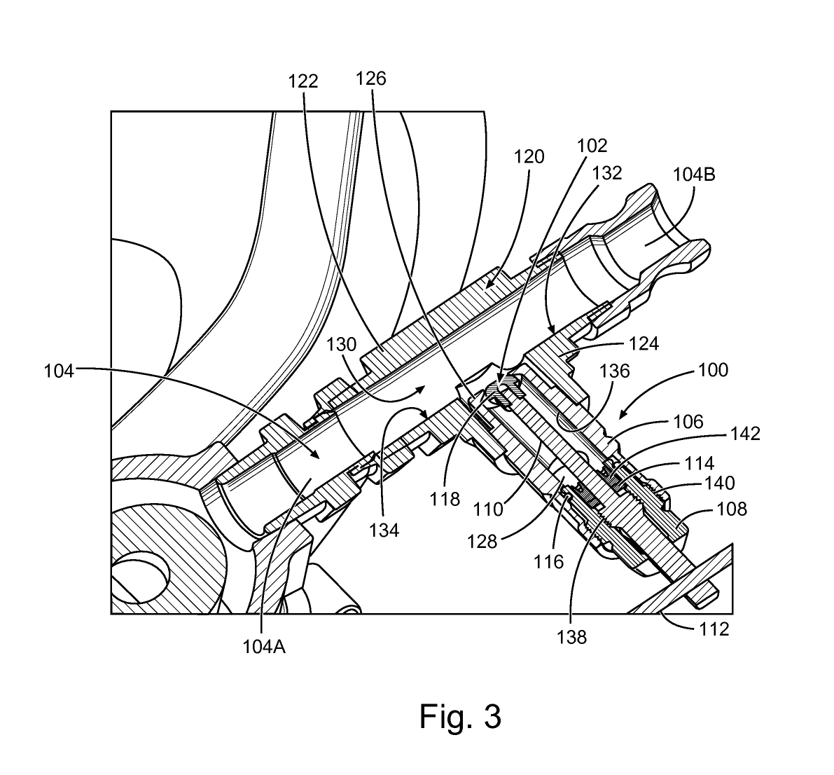

FIG. 3 is a cross-sectional view of minimum cavity relief valve 100 of the present invention in an example mounting for use, in which a relief valve seat 126 configured to be selectively engaged by a valve head 118 (on a valve actuation mechanism 102) is positioned in close proximity to flow line 104. In the depicted example, minimum cavity relief valve 100 comprises housing 106 (including a valve seat 126), a cap 108, a valve mechanism (here in the form of a plunger 110 having a valve head 118), a lever 112, a seal assembly 114, and an O-ring 116.

In the depicted example, relief valve 100 is connected to flow line 104 through a “T” fitting 120. In some embodiments, relief valve 100 will be configured to engage and be retained by a conventional industry standard, “off-the-shelf,” T-fitting, as opposed to, for example, a special function T-fitting configured specifically for housing the relief valve. Use of such special function T-fittings may in some cases complicate assembly and/or maintenance of the systems incorporating such fittings. By way of example only, for some systems that can benefit from use of the relief valve assemblies as described herein, female branch NPT fittings in accordance SAE standard SAE J514, are recognized as industry standard fillings; as are fittings further in accordance with SAE standards SAE 140427, SAE 140438, and SAE 140424. Additional recognized standards may be applicable to T-fittings for various applications, as will be apparent to persons skilled in the art.

As noted relative to FIG. 1, in many applications for relief valve 100, flow line 104 is a high pressure line that extends from a pump outlet to a sprayer, and includes sections 104A and 104B. T-fitting 120 connects sections 104A and 104B with relief valve 100. As such, T-fitting 120 forms a portion of flow line 104. Conduit portion 122 of T-fitting 120 may be connected to sections 104A and 104B in any suitable manner, such as through a threaded connection, to define a portion of the primary flow path 130. Neck 124 of T-fitting 120 defines an aperture 136 forming a relief branch of flow line 104, and extends from conduit portion 122 to couple with housing 106 of relief valve 100.

Thus, housing 106 is configured to place the valve seat 126, which defines an inlet to housing 106, immediately adjacent the primary flow path 130 through flow line 104. In one preferred example, housing 106 is configured to place the lowermost end of the housing, at which valve seat 126 is located, within +/− 0.15 inch of the adjacent surfaces 132, 134 defining primary flow path 130 immediately adjacent aperture 136 within neck 124, in which relief valve 102 is mounted.

Housing 106 may be connected to neck 124 by any suitable manner, such as through a threaded connection, as shown at 138, or a metallurgical connection (welding or brazing). A releasable connection, such as threaded coupling 138, is preferred for many applications. Housing 106 extends between an inlet end, at which valve seat 126 is disposed, and a second end. In the depicted embodiment, the second end is coupled with a cap 108, which accommodates a portion of longitudinally movable valve mechanism 102. Housing 106 includes an outlet port 128 between the inlet and second ends. Outlet port 128 may be coupled to an appropriate fitting to facilitate attachment to a return line (as indicated at 24 in the system drawing of FIG. 1). Cap 108 is threaded to housing 106 and an O-ring 116 is positioned between cap 108 and housing 106 to form a seal therebetween.

In the depicted example, the valve mechanism 102, in the form of plunger 110, extends through and mechanically engages cap 108. As shown, plunger 110 is threaded into cap 108 at a threaded engagement 140, such that a first end extends to selectively engage valve seat 126 at valve head 118, and a second end extends out of housing 106 and through cap 108. Thus, the second end of plunger 110 facilitates control of the position of plunger 110 (and thus control of the valve opening or closing) from outside of the housing 106. Seal 114 is positioned around plunger 110 to prevent material within relief valve 100 from bypassing plunger 110, and exiting from cap 108. In one embodiment, seal 114 comprises one or more U-cup seals disposed within a counter bore 142 around a bore 136 for plunger 110.

A lever 112 is connected to the second end of plunger 110 to provide a mechanical advantage in rotating plunger 110 in the threaded engagement with cap 108 to cause longitudinal movement of valve head 118 relative to housing 106. In one embodiment, lever 112 is inserted into a through-bore in plunger 110. As plunger 110 is rotated, valve head 118 translates longitudinally relative to valve seat 126. Valve head 118 and valve seat 126 are shaped to mate with each other in a closed state to form a seal that prevents material from within conduit portion 122 from entering housing 106. In an open state, material flows into housing 106 and exits at port 128 to relieve pressure in the pumping and spraying system.

In other configurations, the relief valve will not include a separate cap, and the valve member will directly engage housing 106. Such engagement may again be through a threaded coupling, as discussed relative to the depicted example. In other examples, the valve mechanism such that only a portion rotates relative to the housing (to achieve the longitudinal translation), while another part, such as the valve seat, will be restrained from rotating, and will move only longitudinally.

Relief valves relieve pressure from the pumping and spraying system if the system becomes blocked, or “packs out” material. Thus, without proper functioning of a relief valve, the whole system may become inoperable. Typically, relief valves are only flushed when they are actually operated or opened. If the relief valve is not flushed after each use, as is often the case when an operator does not remember to do so, it will become fouled and plugged and cannot be used the next time the system is operated.

Minimum cavity relief valve 100 prevents materials from agglomerating and/or curing within the pressure relief valve itself, thereby eliminating or substantially reducing the operability of the relief valve. Valve seat 126 is positioned in close proximity to conduit portion 122 to substantially eliminate any dead spaces between the primary flow path 130 of conduit portion 122 and valve seat 126. Thus, in selected embodiments, housing 106 is configured such that it extends through neck 124 to support valve seat 126 adjacent conduit portion 122. As such, there is no space for a problematic volume of material to remain in neck 124 below valve seat 126 when valve mechanism 102 is in a closed state.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

What is claimed is:

1. A relief valve comprising:
a housing extending between an inlet end and a second end, the housing having an outlet port formed therein, the housing also having a valve seat at the inlet end; and
a longitudinally moveable valve mechanism assembly within the housing, the valve mechanism moveable between a first position engaging the valve seat to close fluid flow past the valve seat, and a second position spaced from the valve seat to allow fluid flow past the valve seat and to the outlet port.

2. The relief valve of claim 1, further comprising a cap coupled to the housing proximate the second end; and wherein a portion of the longitudinally moveable valve mechanism extends through the cap.

3. The relief valve of claim 1, wherein the longitudinally moveable valve mechanism is configured to move longitudinally in response to rotation of at least a portion of the valve mechanism assembly relative to the housing.

4. The relief valve of claim 3, further comprising a cap coupled to the housing proximate the second end, and wherein at least a portion of the valve mechanism assembly is threadably coupled to at least one of the housing and the cap, to facilitate the longitudinal movement of the valve mechanism assembly.

5. The relief valve of claim 1, wherein the housing is configured to threadably engage a selected industry standard T-fitting.

6. A flow connector, comprising:
a T-fitting forming a primary flow path and a relief branch, the T-fitting configured to couple as part of a flow line in which the primary flow path forms a portion of the flow line; and
a relief valve assembly coupled to the relief branch, the relief valve comprising,
a housing assembly coupled to the relief branch with an opening located adjacent the primary flow path, the housing assembly defining an outlet port,
a valve mechanism coupled in longitudinally moveable relation to the housing between a first position in which it closes the housing opening and a second, longitudinally offset, position in which it opens the housing opening, allowing fluid communication from the flow line, through the housing opening, to the outlet port, and
an actuation mechanism controllable from outside the housing to cause movement of the valve mechanism between the first and second positions.

7. The flow connector of claim 6, wherein the housing opening is in close proximity to the primary flow path.

8. The flow connector of claim 7, wherein the housing opening includes a valve seat for engaging a portion of the valve mechanism.

9. The flow connector of claim 6, wherein the housing opening extends to a depth within 0.15 inch of a surface defining the primary flow path proximate the relief branch.

10. The flow connector of claim 6, wherein the actuation mechanism is manually actuable from outside the housing.

11. The flow connector of claim 6, wherein the valve mechanism is coupled in threaded relation to the housing assembly to facilitate longitudinal movement of the valve mechanism relative to the housing.

12. The flow connector of claim 6, wherein the housing assembly comprises a cap, the cap located generally opposite the housing opening to the relief branch; and wherein the valve mechanism is coupled in threaded relation to the cap to facilitate longitudinal movement of the valve mechanism relative to the housing.

13. The flow connector of claim 6, wherein the actuation mechanism comprises a handle configured to facilitate manual rotation of at least a portion of the valve mechanism.

14. A pumping and spraying system for viscous materials, comprising:
a material reservoir configured to retain a volume of the viscous material;
a pump in fluid communication with the material reservoir;
a flow line coupled to the pump, the flow line defining a primary flow path for the viscous material;
a relief valve coupled to the flow line, the relief valve including,
a housing assembly coupled to the flow line with an inlet located adjacent the primary flow path of the flow line, the housing assembly also defining an outlet port;
a valve mechanism coupled in longitudinally moveable relation to the housing, the valve mechanism moveable between a first position in which it closes the relief valve inlet, and a second, longitudinally offset, position in which it opens the relief valve inlet, allowing fluid communication between the primary flow passage and the outlet port;
an actuation mechanism controllable from outside the housing to cause movement of the valve mechanism between the first and second longitudinally offset positions; and
a spray mechanism in fluid communication with the pump through the flow line to receive material from the pump.

15. The pumping and spraying system of claim 14, wherein the housing inlet is in close proximity to the primary flow path.

16. The pumping and spraying system of claim 14, wherein the housing opening to the relief branch includes a valve seat for engaging a portion of the valve mechanism.

17. The pumping and spraying system of claim 14, wherein the housing opening extends to a depth within 0.15 inch of a surface defining the primary flow path adjacent the intersection of the relief valve with the primary flow path.

18. The pumping and spraying system of claim 14, wherein the valve mechanism is coupled in threaded relation to the housing assembly to facilitate longitudinal movement of the valve mechanism relative to the housing.

19. The pumping and spraying system of claim 14, wherein the housing assembly comprises a cap, the cap located generally opposite the housing opening to the primary flow path; and wherein the valve mechanism is coupled in threaded relation to the cap to facilitate longitudinal movement of the valve mechanism relative to the housing.

20. The pumping and spraying system of claim 14, wherein the flow line extends through an industry standard T-fitting, and wherein the relief valve is coupled to the flow line through the T-fitting.
